(19) United States
(12) Patent Application Publication
(10) Pub. No.: US 2026/0358742 A1
(43) Pub. Date: Nov. 12, 2026

(54) SHEET CONVEYANCE APPARATUS, SHEET CONVEYANCE SYSTEM, AND IMAGE FORMING SYSTEM

(71) Applicant: CANON KABUSHIKI KAISHA, Tokyo (JP)

(72) Inventors: ISAO ITAGAKI, Chiba (JP); HIROSHIGE INOUE, Tokyo (JP)

(21) Appl. No.: 19/653,536

(22) Filed: Apr. 21, 2026

(30) Foreign Application Priority Data
May 8, 2025 (JP) 2025-078140

(51) Int. Cl. G03G 15/00

(52) U.S. Cl. CPC G03G 15/6561; G03G 15/6552; G03G 15/6567; G03G 2215/00383; G03G 2215/00405; G03G 2215/00616; G03G 2215/00679; G03G 2215/00721

(57) ABSTRACT

A sheet conveyance apparatus includes a first guide portion including a first guide and a second guide, the second guide being configured to move to a first position opposing the first guide to form a first conveyance path and to a second position that opens the first conveyance path, a second guide portion disposed downstream of the first guide portion in a sheet conveyance direction and configured to form a second conveyance path, a detection unit disposed on the first guide and configured to detect a position of a side edge of a sheet, a conveyance roller pair disposed in the second guide portion, and a moving unit configured to move the conveyance roller pair based on a detection result of the detection unit in a width direction perpendicular to the sheet conveyance direction in a state in which the sheet is nipped by the conveyance roller pair.

### BACKGROUND

### FIELD OF THE TECHNOLOGY

This disclosure relates to a sheet conveyance apparatus that conveys a sheet, a sheet conveyance system, and an image forming system.

### DESCRIPTION OF THE RELATED ART

In recent years, in image forming systems, a configuration is proposed in which a multi-stage sheet feeding apparatus (200) for feeding a sheet is connected upstream in a sheet conveyance direction of an image forming apparatus (100) (refer to Japanese Patent Laid-Open No. 2021-107280).

### SUMMARY

Incidentally, in multi-stage feeding apparatuses such as that disclosed in Japanese Patent Laid-Open No. 2021-107280, since an image forming apparatus is connected downstream in a sheet conveyance direction, it is difficult to adopt a structure that permits opening and closing of a connection path (202) that serves as a discharge path. Therefore, there is an issue that, in a case where a jam occurs in the connection paths of the multi-stage feeding apparatuses, jam clearance becomes difficult.

According to one aspect of the present disclosure, a sheet conveyance apparatus includes a first guide portion including a first guide and a second guide, the second guide being configured to move to a first position opposing the first guide to form a first conveyance path and to a second position that opens the first conveyance path, a second guide portion disposed downstream of the first guide portion in a sheet conveyance direction and configured to form a second conveyance path, a detection unit disposed on the first guide and configured to detect a position of a side edge of a sheet, a conveyance roller pair disposed in the second guide portion and configured to convey the sheet by nipping the sheet, and a moving unit configured to move the conveyance roller pair based on a detection result of the detection unit in a width direction perpendicular to the sheet conveyance direction in a state in which the sheet is nipped by the conveyance roller pair.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system according to this embodiment.

FIG. 2 is a schematic diagram illustrating a registration unit and a discharge unit according to this embodiment.

FIG. 3 is a perspective view illustrating the discharge unit, each drive motor, and each transmission belt according to this embodiment.

FIG. 4A is a cross-sectional view illustrating the discharge unit according to this embodiment in a state set in an upward position.

FIG. 4B is a cross-sectional view illustrating the discharge unit according to this embodiment in a state set in a downward position.

FIG. 5 is a perspective view illustrating a support frame supported by an apparatus body frame according to this embodiment.

FIG. 6 is a cross-sectional view illustrating the discharge unit according to this embodiment.

FIG. 7A is a cross-sectional view illustrating the discharge unit and an area adjacent thereto in a state in which an opening/closing unit according to this embodiment is brought into a pressing position.

FIG. 7B is a cross-sectional view illustrating the discharge unit and an area adjacent thereto in a state in which the opening/closing unit according to this embodiment is brought into a pressing release position.

FIG. 8 is a perspective view illustrating a movement guide according to this embodiment.

FIG. 9 is a perspective view illustrating the opening/closing unit according to this embodiment.

FIG. 10 is an enlarged perspective view illustrating a pressing portion of the opening/closing unit according to this embodiment.

FIG. 11 is an enlarged cross-sectional view illustrating the pressing portion of the opening/closing unit according to this embodiment.

FIG. 12 is a cross-sectional view illustrating the discharge unit in a state in which the opening/closing unit according to this embodiment is moved to the pressing release position.

### DESCRIPTION OF THE EMBODIMENTS

Hereinafter, embodiments according to this disclosure will be described with reference to the drawings.

### Image Forming System

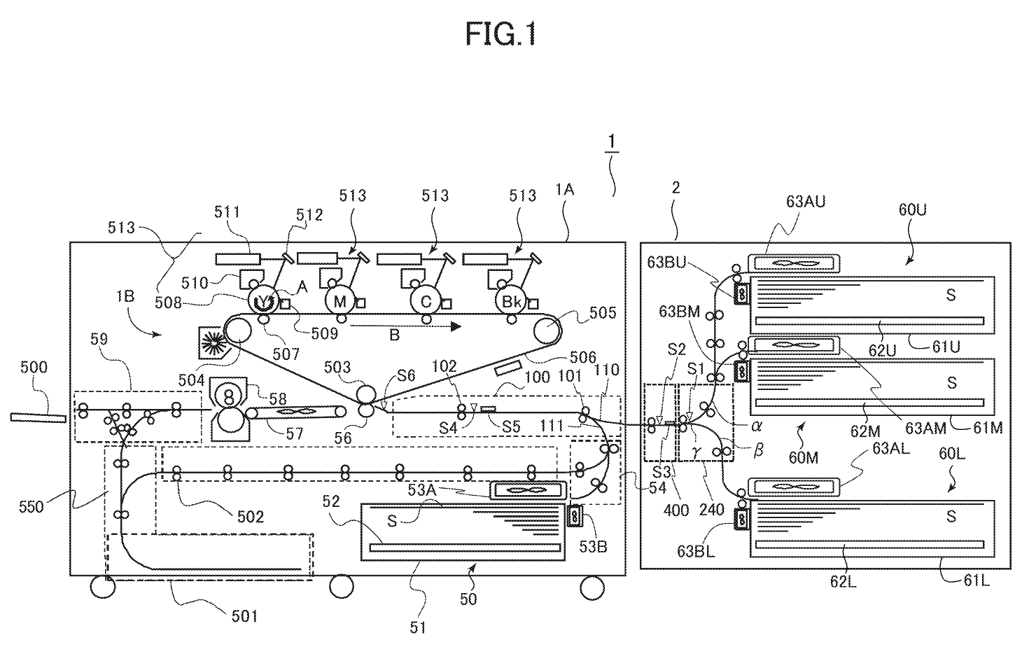

First, an overall configuration of an image forming system 1 according to this embodiment will be described. FIG. 1 is a schematic diagram illustrating the image forming system according to this embodiment. The image forming system 1, which is also a sheet conveyance system, is provided with an image forming apparatus 1A and a sheet feeding apparatus 2 connected to the image forming apparatus 1A. To be noted, the image forming apparatus 1A can also be referred to as a downstream apparatus disposed downstream of the sheet feeding apparatus 2 in a sheet conveyance direction.

The image forming system 1 forms an image on a sheet S using an image forming unit 1B while conveying the sheets S one sheet at a time. As the sheet, which is a recording material (recording medium), various sheet materials having different sizes and materials can be used, including paper such as plain paper and cardstock, sheet materials subjected to surface treatment such as coated paper, sheet materials having special shapes such as envelopes and index paper, plastic films, cloth, and the like.

The image forming apparatus 1A includes the image forming unit 1B of a tandem-type intermediate transfer system in which four process units 513 are arranged along an intermediate transfer belt 506, serving as an intermediate transfer member. Since it is not necessary to retain the sheet S on a transfer drum or a transfer belt, as compared with a case of a direct transfer system, the intermediate transfer system has an advantage of being easily adaptable to various types of the sheet S such as extra-thick paper and coated paper. In addition, the tandem-type intermediate transfer system is suited for achieving high productivity due to its characteristics of parallel processing in the plurality of process units 513 and a collective transfer of a full-color image formed by superimposing toner images of a plurality of colors.

To be noted, the image forming unit 1B is an example of an image forming unit that forms the image on the sheet S, and an electrophotographic unit of the direct transfer system may be used in which a toner image formed on a photosensitive drum 508 is transferred onto the sheet S without interposing the intermediate transfer member. In addition, the image forming unit is not limited to the electrophotographic system, and may be, for example, an inkjet type print unit.

Each process unit 513 includes the photosensitive drum 508, serving as an image bearing member, a charge unit, an exposing unit 511, a developing unit 510, and a cleaning unit 509. The intermediate transfer belt 506 is stretched around a drive roller 504, a tension roller 505, and a secondary transfer inner roller 503, and the intermediate transfer belt 506 is driven for conveyance in a direction B indicated by an arrow in FIG. 1. On an inner circumferential side of the intermediate transfer belt 506, primary transfer rollers 507 are disposed at positions corresponding to each photosensitive drum 508. In addition, on an outer circumferential side of the intermediate transfer belt 506, a secondary transfer roller 56 is disposed at a position opposing the secondary transfer inner roller 503 across the intermediate transfer belt 506.

In addition, the image forming apparatus 1A includes a sheet feeding unit 50, a pre-registration conveyance unit 54, and a registration unit 100. Further, the image forming apparatus 1A includes a pre-fixing conveyance unit 57, a fixing unit 58, a branch conveyance portion 59, a reverse discharge portion 550, a duplex reverse portion 501, and a duplex conveyance portion 502.

The flow of an image forming operation will be described. Here, the sheet S is assumed to be fed from the sheet feeding unit 50 within an apparatus body.

The sheet feeding unit 50 includes a storage chamber 51, which is a so-called cassette, and a lift plate 52 that supports the sheet. Further, the sheet feeding unit 50 is configured to include an air separating unit 53B that blows air onto the sheet supported on the lift plate 52 to separate the sheet, and an air feeding unit 53A that feeds the sheet separated by the air through air absorbing (air suction). The sheet S in the storage chamber 51 is stored in a stacked state on the lift plate 52, and is raised and lowered by a lift-up device (not shown). The sheet S in the storage chamber 51 is separated by the air separating unit 53B blowing strong air onto an end portion on an upstream side in the sheet conveyance direction; thereby, upper several sheets bare separated, and the sheet S is fed one sheet at a time by the air feeding unit 53A in synchronization with the operation timing of the image forming unit 1B. To be noted, sheet feeding methods include air absorbing methods in which the sheet S is attracted to belts by negative pressure generated by fans and conveyed, and roller methods that utilize the frictional force of rollers that rotate in contact with the sheet S. The air feeding unit 53A in FIG. 1 employs the air absorbing method. The sheet S fed by the air feeding unit 53A passes through the pre-registration conveyance unit 54, and is conveyed from a conveyance path 111 to the registration unit 100.

The registration unit 100 is provided with a second pre-registration sensor S4 that detects a leading edge of the sheet S, and a second lateral registration sensor S5 that detects an edge portion in a width direction (hereinafter referred to as "side edge") of the sheet S. Further, the registration unit 100 is provided with a registration roller pair 102. The second lateral registration sensor S5 is constituted by a contact image sensor or the like, and detects a position of the side edge of the sheet S by an image that has been detected. The rotation of the registration roller pair 102 is stopped after a preceding sheet S has passed through, and the leading edge of the sheet S is brought into contact with the registration roller pair 102; thereby, the sheet S is caused to be deflected and the leading edge is caused to follow the registration roller pair 102 to correct skew. Then, based on the timing at which the leading edge of the sheet S is detected by the second pre-registration sensor S4, the registration roller pair 102 starts rotation at a timing at which a predetermined amount of deflection has been formed in the sheet S, and conveys the sheet S. In addition, the registration roller pair 102 is configured to move (shift) in the width direction by a shift mechanism and a shift motor, not shown, and, in a state of nipping the sheet S, performs lateral deviation registration correction of a position in the width direction of the sheet S based on a detection result of the second lateral registration sensor S5.

A pre-registration sensor S6 that detects the leading edge of the sheet S is disposed downstream of the registration unit 100 in the sheet conveyance direction. The registration roller pair 102 measures a delay time of the sheet S with respect to a reference conveyance timing based on the detection result of the pre-registration sensor S6, and, accordingly, a conveyance speed of the sheet S is controlled so as to cancel the delay time. After the skew correction and the lateral deviation registration correction are performed in the registration unit 100, the sheet S is fed to a secondary transfer portion. The secondary transfer portion is a nip portion formed between the secondary transfer roller 56 and the intermediate transfer belt 506.

In parallel with the conveyance operation of the sheet S to the secondary transfer portion described above, the toner image is formed in the image forming unit 1B. The photosensitive drum 508 and the intermediate transfer belt 506 are rotatably driven in predetermined directions A and B. In each process unit 513, a surface of the photosensitive drum 508 is charged by the charge unit. The exposing unit 511 performs the exposure of the photosensitive drum 508 based on image information and writes an electrostatic latent image on the surface of the photosensitive drum 508. The developing unit 510 supplies toner as developer to the photosensitive drum 508, and develops the electrostatic latent image into a monochrome toner image of yellow, magenta, cyan, or black. These monochrome toner images are primarily transferred from the photosensitive drums 508 onto the intermediate transfer belt 506 by the primary transfer rollers 507. At this time, the four-color monochrome toner images overlap each other on the intermediate transfer belt 506; thereby, the full-color image is formed on the intermediate transfer belt 506. Residual toner remaining on the photosensitive drum 508 that was not transferred onto the intermediate transfer belt 506 is removed by the cleaning unit 509.

The full-color image is conveyed to the secondary transfer portion by the rotation of the intermediate transfer belt 506. Then, in the secondary transfer portion, the toner image is transferred from the intermediate transfer belt 506 onto the sheet S by applying voltage to the secondary transfer roller 56.

The sheet S that has passed through the secondary transfer portion is conveyed to the fixing unit 58 by the pre-fixing conveyance unit 57. The fixing unit 58, for example, while nipping and conveying the sheet S by a roller pair, heats the image on the sheet S using heat generated by a heat source, such as a halogen lamp, to fix the image onto the sheet S. By the branch conveyance portion 59, the sheet S that has passed through the fixing unit 58 is either discharged directly toward a sheet discharge tray 500 or guided to the reverse discharge portion 550. By the reverse discharge portion 550, the image forming apparatus 1A can discharge the sheet S onto the sheet discharge tray 500 in a state in which the surface on which the image was transferred in the secondary transfer portion is reversed to face downward (face-down).

To be noted, in a case of duplex printing in which the images are formed on both sides of sheet S, the sheet S on which the image has been formed on a first surface thereof is sent from the branch conveyance portion 59 to the duplex reversing portion 501 through the reverse discharge portion 550. Then, the sheet S that has been switchbacked in the duplex reversing portion 501 is sent again to pre-registration conveyance unit 54 via the duplex conveyance portion 502. Thereafter, after the image is formed on a second surface in the same manner as the first surface, the sheet S is discharged to the sheet discharge tray 500.

To be noted, the sheet fed from the sheet feeding apparatus 2 described below is conveyed to the registration unit 100 via a merging conveyance path 110 through which the sheet from the sheet feeding apparatus 2 is merged. A subsequent operation after the pre-registration conveyance unit 54 is the same as in the case where the sheet S is fed from the storage chamber 51.

### Sheet Feeding Apparatus

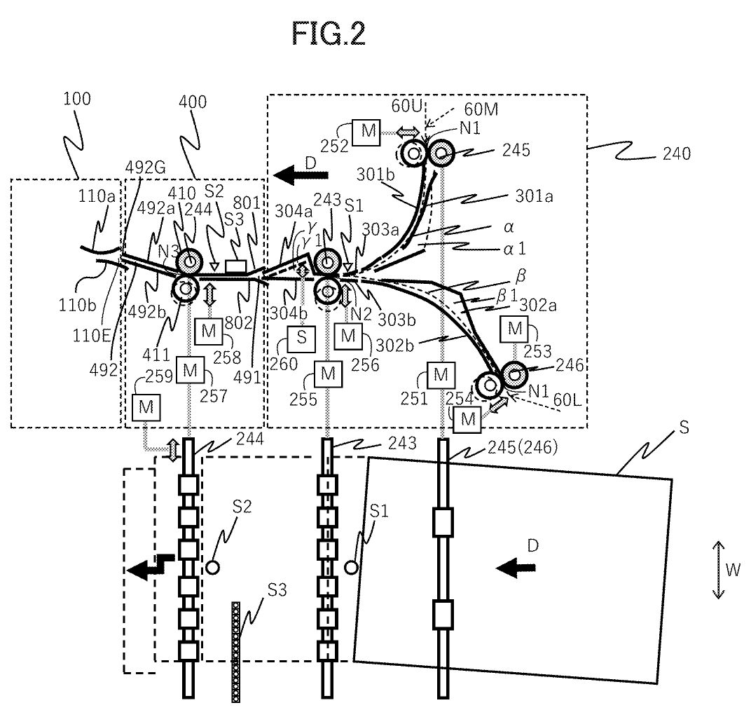

Next, the sheet feeding apparatus 2, serving as a sheet conveyance apparatus according to this embodiment, will be described. In this embodiment, the sheet feeding apparatus 2 feeds the sheet S toward the image forming apparatus 1A. As illustrated in FIG. 1, the sheet feeding apparatus 2 according to this embodiment includes sheet feeding units 60U, 60M, and 60L, serving as three-stage feeding units arranged vertically. In addition, the sheet feeding apparatus 2 includes a registration unit 240 for performing the skew correction of the sheet S. Further, the sheet feeding apparatus 2 is provided with a discharge unit 400, serving as a conveyance unit, including a discharge path 492 (refer to FIG. 2), serving as a discharge guide portion that performs the lateral registration correction of the sheet S and discharges the sheet to the image forming apparatus 1A.

Each of the sheet feeding units 60U, 60M, and 60L includes a configuration similar to the sheet feeding unit 50 within the apparatus body. That is, each of the sheet feeding units 60U, 60M, and 60L includes a storage chamber 61U, 61M, 61L, which is a so-called cassette, and a lift plate 62U, 62M, 62L that supports the sheet. In addition, each of the sheet feeding units 60U, 60M, and 60L includes an air separating unit 63BU, 63BM, 63BL that blows air onto the sheet supported by the lift plate 62U, 62M, 62L to separate the sheet. Then, each of the sheet feeding units 60U, 60M, and 60L includes an air feeding unit 63AU, 63AM, 63AL that feeds the sheet separated by the air through air absorbing. The sheet S in the storage chamber 61U, 61M, 61L is stored in a stacked state on the lift plate 62U, 62M, 62L, and is raised and lowered by a lift-up device (not shown). The sheet S in the storage chamber 61U, 61M, 61L is separated by the air separating unit 63BU, 63BM, 63BL, which blows strong air onto an upstream end portion in the sheet conveyance direction; thereby, several upper sheets are separated. Then, the separated sheet S is fed one sheet at a time by the air feeding unit 63AU, 63AM, 63AL.

The sheet S fed from the upper and middle sheet feeding units 60U and 60M is conveyed through an upper conveyance path α, which is a sheet conveyance path. The sheet fed from the lower sheet feeding unit 60L is conveyed through a lower conveyance path β, which is a sheet conveyance path. The upper and lower conveyance paths α and β merge at the registration unit 240 to form a horizontal path γ, which is a sheet conveyance path. The horizontal path γ extends in a substantially horizontal direction, communicates with a conveyance path 491 (refer to FIG. 2) of the discharge unit 400, and communicates with the merging conveyance path 110 of the image forming apparatus 1A via the discharge path 492 (refer to FIG. 2). Therefore, the sheet S fed from each sheet feeding unit 60U, 60M, 60L is conveyed to the image forming apparatus 1A via the registration unit 240 and the discharge unit 400.

Similarly to the sheet feeding unit 50 of the image forming apparatus 1A, in the image forming operation, the sheet S is fed from any one of the sheet feeding units 60U, 60M, and 60L in synchronization with the operation timing of the image forming unit 1B. A pre-shift sensor S2, serving as a first detection unit, that detects the leading edge of the sheet S is disposed in the discharge unit 400. A control unit of the image forming apparatus 1A temporarily stops a discharge roller pair 244 based on the detection of the leading edge of the sheet by the pre-shift sensor S2, and causes the sheet S to abut against a nip portion N3 and deflect. Thereafter, based on the detection timing of the leading edge of the sheet by the pre-shift sensor S2, the discharge roller pair 244 is driven in synchronization with the operation timing of the image forming unit 1B, and resumes the conveyance of the sheet S. Thereby, it is possible to feed the sheet S to the image forming apparatus 1A in a state in which, while correcting the skew of the sheet, variations in conveyance timing that occurred inside the sheet feeding apparatus 2 are adjusted.

### Schematic Configuration of Registration Unit and Discharge Unit

Next, a schematic configuration of the registration unit 240 and the discharge unit 400 according to this embodiment will be described. FIG. 2 is a schematic diagram illustrating the registration unit and the discharge unit according to this embodiment. To be noted, as illustrated in FIG. 2, a direction in which the sheet is conveyed in the registration unit 240 and the discharge unit 400 is referred to as a sheet conveyance direction D, and a direction that is perpendicular to the sheet conveyance direction and also is the width direction of the sheets is referred to as a width direction W. In addition, the width direction W is a front-rear direction of the sheet feeding apparatus 2 or the image forming apparatus 1A, and in this specification, the front is also referred to as a front side and the rear is also referred to as a rear side. In addition, generally, the front in the sheet feeding apparatus 2 or the image forming apparatus 1A is a direction toward which an operation panel (not shown) is directed.

As illustrated in FIG. 2, the registration unit 240 includes a registration roller pair 243, an upper conveyance roller pair 245, and a lower conveyance roller pair 246. In addition, the discharge unit 400 includes the discharge roller pair 244, serving as a conveyance unit or a conveyance roller pair. To be noted, as described in detail below, also the discharge roller pair 244 is configured to perform skew correction. Therefore, the registration roller pair 243 can be considered as a first registration roller pair, and the discharge roller pair 244 can be considered as a second registration roller pair disposed downstream of the first registration roller pair.

The registration roller pair 243 and the discharge roller pair 244 are disposed in the horizontal path γ. In the sheet conveyance direction D in the horizontal path γ, the discharge roller pair 244 is positioned downstream of the registration roller pair 243.

The upper conveyance roller pair 245 is disposed in the upper conveyance path α, and is positioned upstream of the registration roller pair 243 in the sheet conveyance direction D in the upper conveyance path α. The lower conveyance roller pair 246 is disposed in the lower conveyance path β, and is positioned upstream of the registration roller pair 243 in the sheet conveyance direction D in the lower conveyance path β.

The upper conveyance roller pair 245 is constituted by a drive roller that is rotatably driven by a driving force of a conveyance motor 251 (M in FIG. 2 indicates a motor), and a driven roller that forms a nip portion N1 together with the drive roller and rotates by following the drive roller. In addition, the upper conveyance roller pair 245 is configured such that the drive roller and the driven roller are brought into contact with and separated from each other (open and close the nip portion N1) by a driving force of a separation motor 252.

In addition, similarly, the lower conveyance roller pair 246 is constituted by a drive roller that is rotatably driven by a driving force of a conveyance motor 253, and a driven roller that forms a nip portion N4 together with the drive roller and rotates by following the drive roller. In addition, the lower conveyance roller pair 246 is configured such that the drive roller and the driven roller are brought into contact with and separated from each other (open and close the nip portion N4) by a driving force of a separation motor 254.

In addition, similarly, the registration roller pair 243 is constituted by a drive roller that is rotatably driven by a driving force of a conveyance motor 255, and a driven roller that forms a nip portion N2 together with the drive roller and rotates by following the drive roller. In addition, the registration roller pair 243 is configured such that the drive roller and the driven roller are brought into contact with and separated from each other (open and close the nip portion N2) by a driving force of a separation motor 256.

Then, similarly, the discharge roller pair 244 is constituted by a drive roller that is rotatably driven by a driving force of a conveyance motor 257, and a driven roller that forms the nip portion N3 together with the drive roller and rotates by following the drive roller. In addition, the discharge roller pair 244 is configured such that the drive roller and the driven roller are brought into contact with and separated from each other (open and close the nip portion N3) by a driving force of a separation motor 258.

Accordingly, in this embodiment, the rotary drive of each roller pair (243, 244, 245, 246) is configured to be controlled independently. In addition, each roller pair (243, 244, 245, 246) is configured such that the drive and driven rollers are independently controlled to be brought into contact with or separated from each other (open and close the nip portions).

Further, the discharge roller pair 244 is configured to shift in the sheet width direction by a driving force of a shift motor 259. The sheet width direction is a direction parallel to a rotational axis of the discharge roller pair 244. The shift motor 259 functions as a movement driving unit or a moving unit for the lateral deviation registration correction, which moves the discharge roller pair 244 in the sheet width direction based on a detection result of a first lateral registration sensor S3 to correct a positional deviation in the width direction.

Between the upper conveyance roller pair 245 and the registration roller pair 243, the upper conveyance path α is formed by an upper guide 301a and a lower guide 301b. Between the upper conveyance roller pair 245 and the registration roller pair 243, the upper conveyance path α is curved such that the lower guide 301b is positioned on an outer side of the curvature and the upper guide 301a is positioned on an inner side of the curvature. The upper guide 301a is a swing guide urged by a spring (not shown), and is configured such that, when a loop is formed by the sheet S, the guide pivots so as to curve in an outward direction, and, thereby, forms a space α1 that permits the formation of the loop which is formed when the sheet abuts against the nip portion of the registration roller pair 243. Thereby, for example, in a thick-paper mode in which a type of the sheet to be supplied is thick paper, the skew correction can be performed in a state in which the sheet S is significantly curved along the curved upper conveyance path α. As a result, the possibility of defective skew correction due to leading edge penetration at the registration roller pair 243 or due to the slippage of the upper conveyance roller pair 245 is more reliably reduced.

Between the lower conveyance roller pair 246 and the registration roller pair 243, the lower conveyance path β is formed by an upper guide 302a and a lower guide 302b. The lower conveyance path β is curved between the lower conveyance roller pair 246 and the registration roller pair 243 such that the lower guide 302b is positioned on an inner side of the curvature and the upper guide 302a is positioned on an outer side of the curvature. A distance between the lower guide 302b (inner guide) and the upper guide 302a (outer guide) is wider at an intermediate portion between the lower conveyance roller pair 246 and the registration roller pair 243 as compared to distances at portions adjacent to the lower conveyance roller pair 246 and the registration roller pair 243. Therefore, a space β1, which permits the sheet S to deflect (form a loop) toward the outer side of the curvature of the lower conveyance path β, is formed at the intermediate portion between the lower conveyance roller pair 246 and the registration roller pair 243. Accordingly, similarly, for example, in the thick paper mode, the skew correction can be performed in a state in which the sheet S is significantly curved along the curved lower conveyance path β. As a result, the possibility of defective skew correction due to leading edge penetration at the registration roller pair 243 or due to the slippage of the lower conveyance roller pair 246 is more reliably reduced.

The upper and lower conveyance paths α and β merge at a position adjacent to an upstream side of the registration roller pair 243. A conveyance path disposed further downstream than the merging portion of the upper and lower conveyance paths α and β is formed by an upper guide 303a and a lower guide 303b.

The horizontal path γ is formed by an upper guide 304a and a lower guide 304b between the registration roller pair 243 and the discharge roller pair 244. In the horizontal path γ, a portion of the upper guide 304a is recessed upward. In other words, the upper guide 304a includes a recess portion formed such that a portion of the upper guide 304a in the sheet conveyance direction D is spaced apart (retracts) from the lower guide 304b. Thereby, a space γ1, which permits the sheet S to deflect (form a loop) toward an upward direction, is formed between the registration roller pair 243 and the discharge roller pair 244. That is, the space γ1 for receiving a loop L of the sheet S, for example, in a thin paper mode in which a type of the sheet to be supplied is thin paper, is provided in an upper portion of the horizontal path γ. Since thin paper (particularly, ultra-thin paper) has low rigidity, if the space γ1 for receiving the loop L were provided in a lower portion of the horizontal path γ, the sheet S would deflect toward the space γ1 before loop formation; therefore, there is the possibility of causing defective skew correction. With the configuration of this embodiment, such inconvenience can be avoided.

To be noted, the lower guide 304b serves as a flapper guide, and the lower guide 304b retracts toward a side of the upper guide 304a via a solenoid 260 and a link mechanism (not shown); thereby, multi-fed sheets or a jammed sheet can be discharged toward a lower side of the horizontal path γ.

The registration unit 240 includes a first pre-registration sensor S1, and the discharge unit 400 includes a pre-shift sensor S2, serving as a first detection unit, and the first lateral registration sensor S3, serving as a second detection unit or a detection unit, which is an image reading sensor that performs the image detection of the side edge of the sheet. The first pre-registration sensor S1 is disposed in an area adjacent to the upstream side of the registration roller pair 243. The pre-shift sensor S2 and the first lateral registration sensor S3 are disposed in an area adjacent to an upstream side of the discharge roller pair 244.

The first pre-registration sensor S1 and the pre-shift sensor S2 are used to obtain passage timings of the leading edge and trailing edge of the sheet S for controlling a sheet conveyance operation. The first pre-registration sensor S1 is used for conveyance control including, for example, the control of a deflection amount (loop amount) when abutting the leading edge of the sheet S against the nip portion N2 of the registration roller pair 243 to correct skew. The pre-shift sensor S2 is used for conveyance control including, for example, the control of a deflection amount (loop amount) when abutting the leading edge of the sheet S against the nip portion N3 of the discharge roller pair 244 to correct skew.

The first lateral registration sensor S3 is, for example, a contact image sensor (CIS) type line sensor including light-receiving elements arranged in the sheet width direction. The first lateral registration sensor S3 is capable of obtaining information on the position of the side edge of the sheet S in the sheet width direction. The first lateral registration sensor S3 is used for the alignment (lateral registration) of the image formed by the image forming unit 1B on the sheet S with respect to the sheet width direction (main scanning direction). In this embodiment, the lateral deviation registration correction (lateral registration) is performed by shifting the discharge roller pair 244 in the sheet width direction based on the detection result of the first lateral registration sensor S3 in a state in which the discharge roller pair 244 is nipping the sheet S. To be noted, when performing the lateral deviation registration correction, by driving the separation motor 256, the drive roller and the driven roller are brought into pressure contact with each other to nip the sheet, and the shift motor 259 moves the sheet in the width direction. In addition, the shift motor 259, after performing the lateral deviation registration correction, returns a position in the sheet width direction of the discharge roller pair 244 to an initial position. At this time, the separation motor 256 separates the drive roller and the driven roller to release the sheet.

The sheet S that has undergone the lateral deviation registration correction as described above is conveyed to the discharge path 492, serving as a second guide portion, formed by an upper guide 492a and a lower guide 492b. Then, the sheet is discharged from a discharge port 492G of the discharge path 492, and is delivered to the merging conveyance path 110 of the image forming apparatus 1A. The merging conveyance path 110 is formed by an upper guide 110a and a lower guide 110b, and the upper and lower guides 110a and 110b are formed such that a receiving port 110E, which is an upstream end in the sheet conveyance direction D, is formed to be wider than the discharge port 492G of the discharge path 492. To be noted, since a position of the receiving port 110E of the image forming apparatus 1A is determined, as described in detail below, it becomes necessary to align a position of the discharge port 492G in the vertical direction by pivoting the discharge path 492 in the vertical direction.

### Configuration of Discharge Unit

In recent years, due to demands for storing a plurality of types of media and large volumes of sheets, by connecting a plurality of sheet feeding apparatuses in the sheet conveyance direction, or by connecting a plurality of other processing apparatuses, overall systems increase in size, and conveyance paths become longer; thereby, sheets become more likely to cause positional deviations in the width direction. In addition, when sheet feeding methods employ air feeding configurations using air absorbing methods and air separation methods as in this embodiment, the positional deviations of the sheets tend to become greater than, for example, roller-based feeding methods. If an attempt is made to correct such large positional deviations of the sheets in the width direction in a single operation, residual positional deviations may occur, and deterioration in the quality of deliverables may result.

In addition, in sheet feeding apparatuses such as that of this embodiment, since sheets are fed from a plurality of sheet feeding units, merging portions at which conveyance paths merge are necessary. Further, downstream in the sheet conveyance direction of the merging portions, escape flapper portions for discharging multi-fed or jammed sheets and loop spaces for correcting skew are sometimes provided. Then, in order to correct positional deviations of sheets in the width direction, it is necessary to dispose sensors for detecting the positional deviations and roller pairs capable of moving the sheets in the width direction at positions downstream of the escape flapper portions or the loop spaces, i.e., at positions at which the conveyance of the sheets to downstream apparatuses is assured.

In addition, discharge paths for discharging sheets are required to be pivotably disposed so as to reliably deliver high-rigidity sheets to subsequent apparatuses.

However, when units that perform the lateral deviation registration correction of the sheets, and units that are pivotably configured and discharge the sheets are disposed along the sheet conveyance direction as described above, there is an issue that the sheet conveyance apparatuses may be increased in size. In particular, in image forming systems which are required to connect a plurality of sheet feeding apparatuses, the overall systems may increase in size. Therefore, in this embodiment, as described below, the discharge unit 400 is integrally provided with the discharge path 492 and the discharge roller pair 244 that also serves as a registration roller pair capable of performing the lateral deviation registration correction and the skew correction.

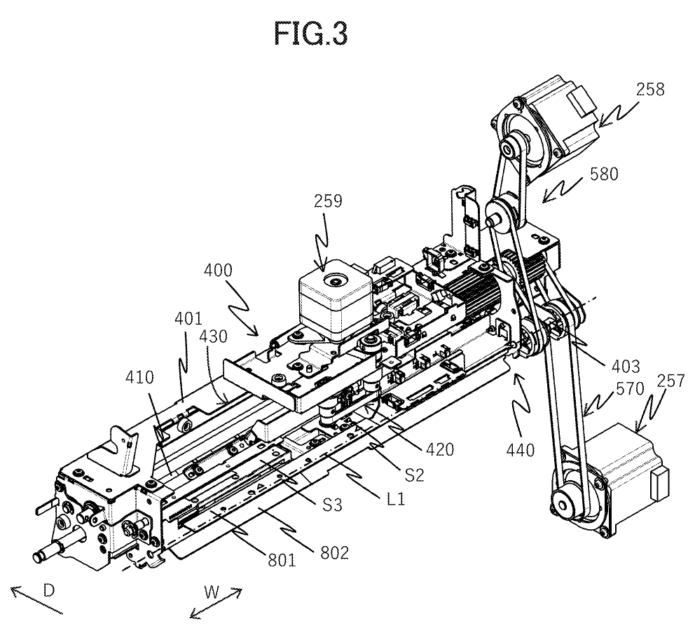

Here, using FIGS. 2 and 3, a configuration of the discharge unit 400 according to this embodiment will be described in detail. FIG. 3 is a perspective view illustrating the discharge unit, each drive motor, and each transmission belt according to this embodiment, that is, a diagram illustrating the discharge unit 400, drive sources connected to the discharge unit 400, and drive transmission paths thereof.

As illustrated in FIG. 2, the discharge roller pair 244 described above is disposed between conveyance path 491 and the discharge path 492, which constitute a conveyance path of the discharge unit 400. The discharge roller pair 244 forms the nip portion N3 with a discharge drive roller 410, serving as a drive roller, and a discharge driven roller 411, serving as a driven roller; thereby, the discharge roller pair 244 nips the sheet S for conveyance downstream in the sheet conveyance direction D. As illustrated in FIG. 3, the discharge drive roller 410 is rotated when drive rotation, which is output from the conveyance motor 257, serving as a conveyance drive unit, is transmitted via a conveyance transmission portion 570, which is constituted by a belt and a pulley; thereby, the discharge drive roller 410 conveys the sheet S in the sheet conveyance direction D.

In addition, it is possible to open the nip portion N3 by separating the discharge driven roller 411 from the discharge drive roller 410. That is, when drive rotation from the separation motor 258 is transmitted via a separation transmission portion 580, which is constituted by a belt and a pulley, and a separation mechanism 440 is driven, the discharge driven roller 411 is separated from the discharge drive roller 410.

Further, the discharge roller pair 244 is supported by a shift roller unit 430, and, when moving the shift roller unit 430, the discharge roller pair 244 is configured to move so as to shift in the width direction W (axial direction of roller) perpendicular to the sheet conveyance direction D. That is, drive rotation from the shift motor 259, serving as a movement driving unit, is transmitted to a shift drive unit 420, and the shift roller unit 430 is moved by the shift drive unit 420 so as to shift in the width direction W.

Around the discharge unit 400 that operates as described above, the conveyance motor 257 and the conveyance transmission portion 570, and the separation motor 258, serving as a separation drive unit, and the separation transmission portion 580 are disposed. Then, the discharge unit 400 includes a support frame 401, and, in a form of being supported by the support frame 401, is provided with the shift motor 259, the shift drive unit 420, and the shift roller unit 430 including the discharge roller pair 244. In addition, the discharge unit 400 is provided with, in a form of being supported by the support frame 401, the separation mechanism 440.

In addition, as illustrated in FIGS. 2 and 3, upstream of the discharge roller pair 244 in the sheet conveyance direction D, in a form of being supported by the support frame 401, the discharge unit 400 includes a sensor fixing guide 801 and an opposing guide 802 that form the conveyance path 491, serving as a first guide portion. Further, the pre-shift sensor S2 for detecting the sheet S and the first lateral registration sensor S3 for detecting the positional information of the edge portion of the sheet S in the axial direction of the roller are disposed on the sensor fixing guide 801, serving as a first guide. The opposing guide 802, serving as a second guide, is disposed opposite to the first lateral registration sensor S3, and forms the conveyance path 491 in which a reading position of the first lateral registration sensor S3 is disposed. In addition, downstream of the discharge roller pair 244 in the sheet conveyance direction D, the discharge unit 400 is provided with the upper guide 492a and the lower guide 492b that form the discharge path 492 for delivering the sheet to the merging conveyance path 110 of the registration unit 100 of the image forming apparatus 1A. Accordingly, in a form of being supported by the support frame 401, the discharge unit 400 is provided with the sensor fixing guide 801 and the opposing guide 802, the pre-shift sensor S2, the first lateral registration sensor S3, and the upper guide 492a and the lower guide 492b.

As described above, the discharge unit 400, which supports each constituting component on the support frame 401, is pivotably supported with respect to an apparatus body frame 201 provided in the sheet feeding apparatus 2. Hereinafter, a structure for pivotably supporting the discharge unit 400 will be described.

### Pivotable Supporting Configuration of Discharge Unit

To reliably deliver the high-rigidity sheet from the sheet feeding apparatus 2 to the image forming apparatus 1A, it is desirable that the curvature of the conveyance path which connects these apparatuses (particularly between the horizontal path γ and the conveyance path 491, and between the discharge path 492 and the merging conveyance path 110) is configured to be gradual. In a case where the curvature of the conveyance path is sharp, when conveying the high-rigidity sheet, conveyance resistance may increase; therefore, there is a concern that motor step-out may occur due to insufficient torque in a conveyance motor for sheet conveyance, and a conveyance failure may result. In addition, there is a concern that slippage may occur between the sheet and a roller pair, and a roller slip mark may be formed on the sheet; thereby, the quality of deliverables may deteriorate.

In this embodiment, to resolve such issues, the support frame 401 of the discharge unit 400 is pivotably supported with respect to the apparatus body frame 201 of the sheet feeding apparatus 2, and thereby a support angle of the discharge unit 400 is configured to be adjusted. This achieves the formation of a gradually curved conveyance path from the horizontal path γ of the registration unit 240 to the conveyance path 491 of the discharge unit 400, and from the discharge path 492 to the merging conveyance path 110 of the registration unit 100.

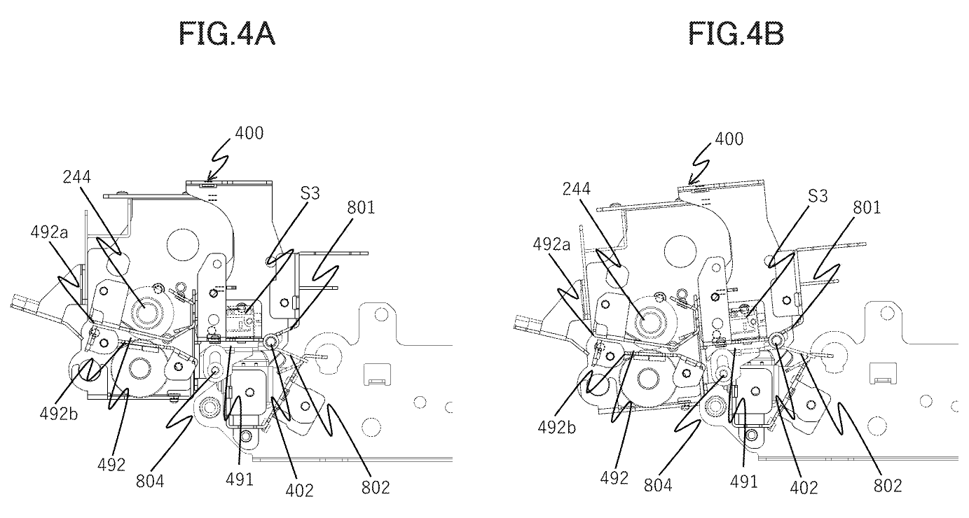

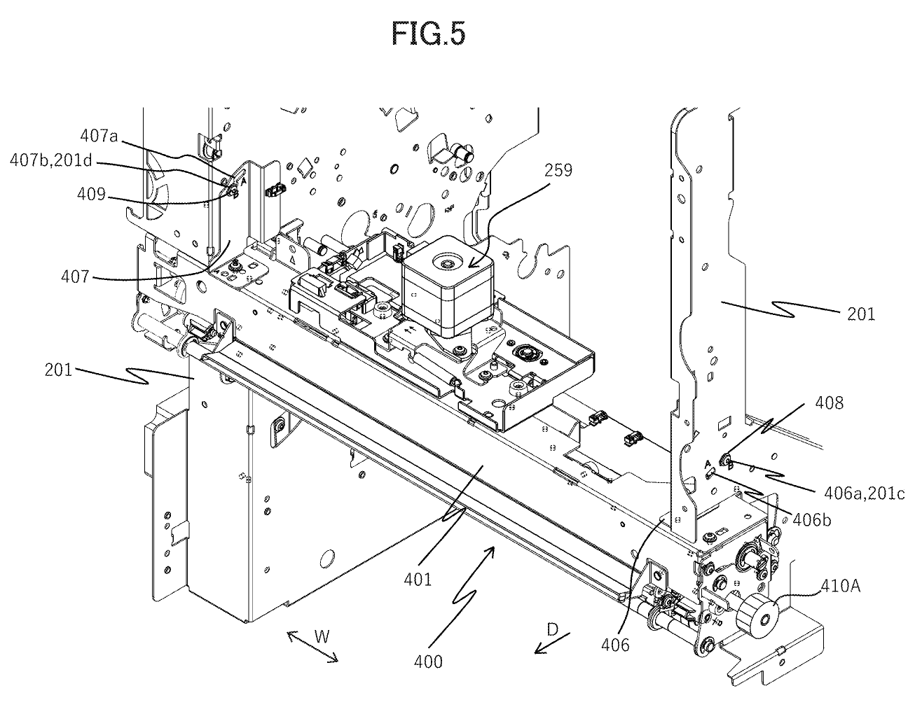

Here, using FIGS. 4A to 5, the structure for pivotably supporting the support frame 401 of the discharge unit 400 with respect to the apparatus body frame 201 of the sheet feeding apparatus 2 will be described in detail. FIG. 4A is a cross-sectional view illustrating a state in which the discharge unit is set in an upward position. FIG. 4B is a cross-sectional view illustrating a state in which the discharge unit is set in a downward position. FIG. 5 is a perspective view illustrating a state in which the support frame supported by the apparatus body frame according to this embodiment is viewed from downstream in the sheet conveyance direction.

The support frame 401 of the discharge unit 400 is formed with through holes (not shown) at a first end on one side (front side) and at a second end on the other side (rear side) in the width direction W. In addition, also the apparatus body frame 201 (refer to FIG. 5) of the sheet feeding apparatus 2 is formed with through holes at a first end on the one side (front side) and at a second end on the other side (rear side) in the width direction W. Then, at the first ends on the one side in the width direction W, a front side pivot shaft 402 (refer to FIGS. 4A and 4B), serving as a third pivot shaft, is inserted into the through hole of the support frame 401 and the through hole of the apparatus body frame 201. Similarly, at the second ends on the other side in the width direction W, a rear side pivot shaft 403 (refer to FIG. 3), serving as a third pivot shaft, is inserted into the through hole of the support frame 401 and the through hole of the apparatus body frame 201. Thereby, the discharge unit 400 (the support frame 401 thereof) is pivotably supported with respect to the apparatus body frame 201, using the front and rear side pivot shafts 402 and 403 as fulcrums.

In this embodiment, as illustrated in FIGS. 4A and 4B, an axial center of the front side pivot shaft 402 (and the rear side pivot shaft 403) is disposed adjacent to an upstream end portion in the conveyance path 491 with respect to the sheet conveyance direction D. By disposing the pivot fulcrums as described above, a downstream end portion of the horizontal pass γ (refer to FIG. 2) and the upstream end portion of the conveyance path 491 become substantially coincident in position regardless of a pivot angle of the discharge unit 400. Thereby, it is possible to smoothly perform the delivery of the sheet between the registration unit 240 and the discharge unit 400.

In addition, as illustrated in FIG. 5, brackets 406 and 407 are fixed to an upper portion of the support frame 401 of the discharge unit 400 at positions adjacent to both ends in the width direction W. The bracket 406 is formed with pivot range restriction holes 406a and 406b that are formed in a shape of an elongated hole along an arc centered on the axial centers of the front and rear side pivot shafts 402 and 403, and penetrate through the bracket 406. Similarly, the bracket 407 is formed with pivot range restriction holes 407a and 407b that are formed in an elongated hole shape along an arc centered on the axial centers of the front and rear side pivot shafts 402 and 403, and penetrate through the bracket 407. In addition, a screw hole 201c is formed in the apparatus body frame 201 at a position that enables alignment with the pivot range restriction holes 406a and 406b in the width direction W. Further, similarly, a screw hole 201d is formed in the apparatus body frame 201 at a position that enables alignment with the pivot range restriction holes 407a and 407b in the width direction W.

Then, by screwing a screw 408 into the screw hole 201c through the pivot range restricting hole 406a or 406b, and screwing a screw 409 into the screw hole 201d through the pivot range restricting hole 407a or 407b, the discharge unit 400 can be positioned and secured to the apparatus body frame 201. Then, positions at which the screws 408 and 409 are fastened to the pivot range restricting hole 406a or 406b and the pivot range restricting hole 407a or 407b are selected. Thereby, an angle of the discharge unit 400, in which the front and rear side pivot shafts 402 and 403 serve as fulcrums, can be selected with respect to the apparatus body frame 201. In other words, the discharge unit 400 can be selectively set at two stages of positions: the state in which the discharge path 492 is set in the upward position as illustrated in FIG. 4A, and the state in which the discharge path 492 is set in the downward position as illustrated in FIG. 4B.

### Configuration for Determining Pivot Position of Discharge Unit

Next, a configuration for determining a pivot position (angle) of the discharge unit 400 such that, in a case where the image forming apparatus 1A and the sheet feeding apparatus 2 are connected, the discharge path 492 and the merging conveyance path 110 form an appropriate angle will be described.

Prior to connecting the image forming apparatus 1A and the sheet feeding apparatus 2, the discharge unit 400 is positioned using a range of adjustment tolerances of the pivot range restriction holes 406a and 406b and the pivot range restriction holes 407a and 407b such that the upper and lower guides 492a and 492b are oriented vertically upward. Then, in this state, the discharge unit 400 is provisionally secured using the screws 408 and 409. Thereby, in the case of connecting the image forming apparatus 1A and the sheet feeding apparatus 2, contact between the upper and lower guides 492a and 492b of the discharge path 492 and the upper and lower guides 110a and 110b of the merging conveyance path 110 is prevented.

Next, when loosening the screws 408 and 409, the discharge unit 400 pivots under its own weight, and, thereby, the lower guide 492b of the discharge path 492 comes into contact with the lower guide 110b of the merging conveyance path 110, so that the discharge unit 400 is brought into a state in which pivotal movement is restricted. Then, thereafter, the discharge unit 400 is secured to the apparatus body frame 201 using the screws 408 and 409. In this manner, the conveyance path for delivering the sheet from the discharge path 492 of the discharge unit 400 to the merging conveyance path 110 of the image forming apparatus 1A obtains an appropriate cross-sectional configuration having a gradual curvature when viewed from the width direction W; thereby, it becomes possible to stably and accurately convey even the high-rigidity sheet.

In addition, as described above, the pivot range restriction holes 406a and 406b and the pivot range restriction holes 407a and 407b are configured to permit the discharge unit 400 to pivot to different angles, that is, are configured such that the discharge path 492 corresponds to a different discharge angle. With this configuration, the sheet feeding apparatus 2 can be connected even to an image forming apparatus in which the height of a merging conveyance path 110 differs.

### Configurations of Opposing Guide of Discharge Unit and Opening/closing Unit

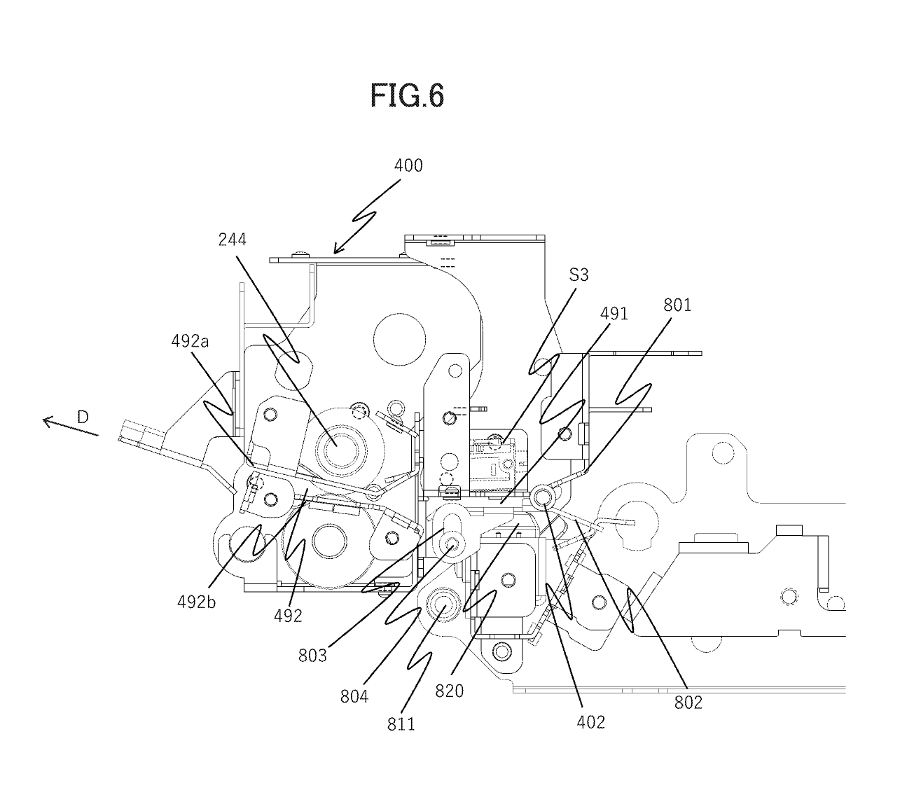

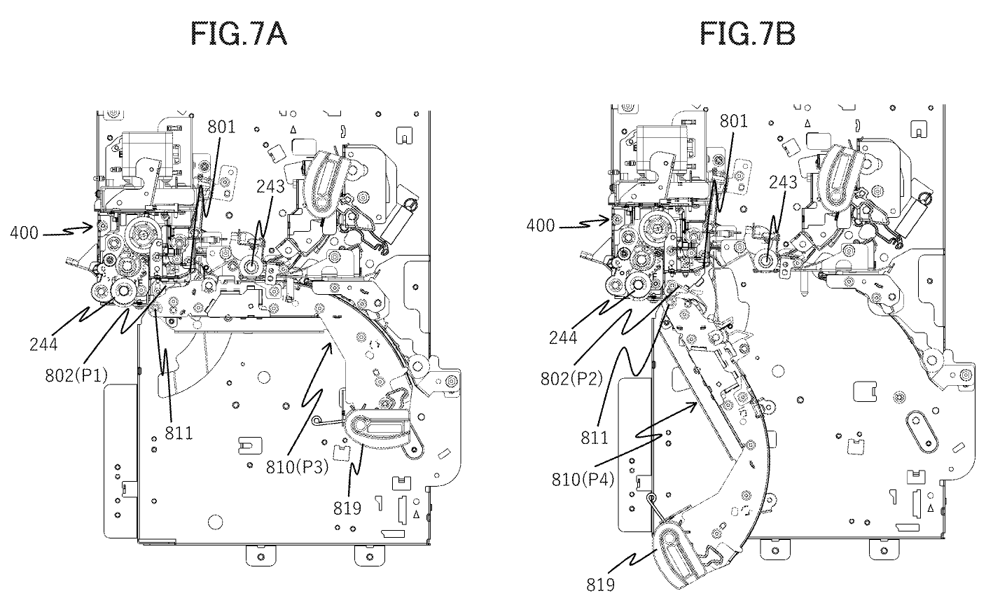

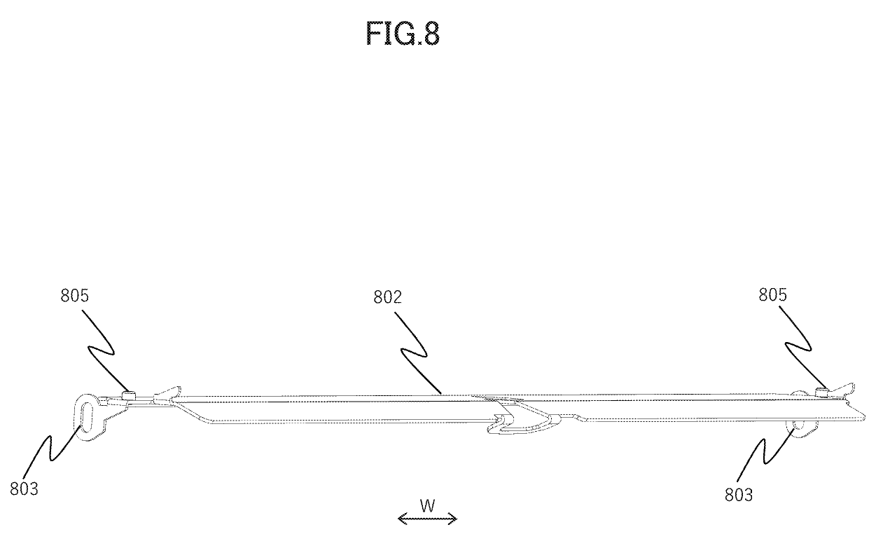

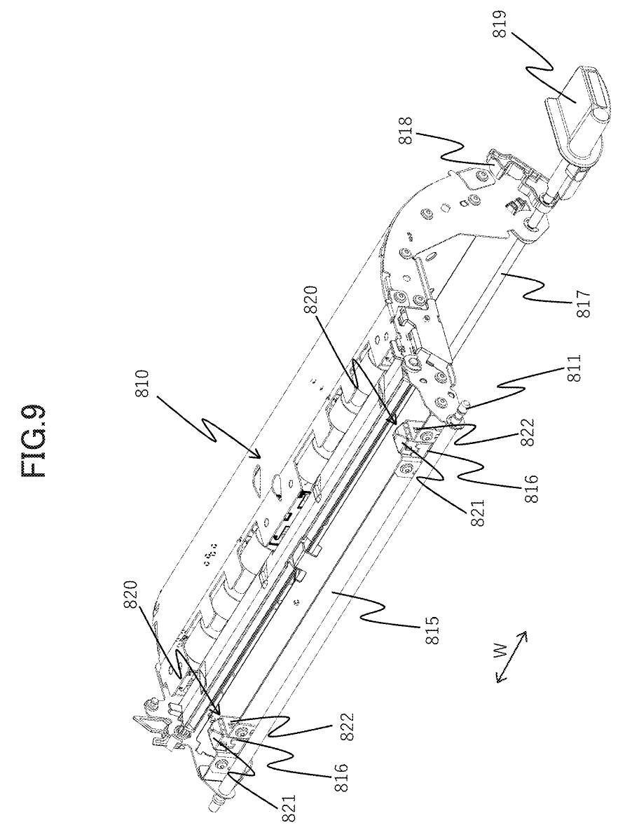

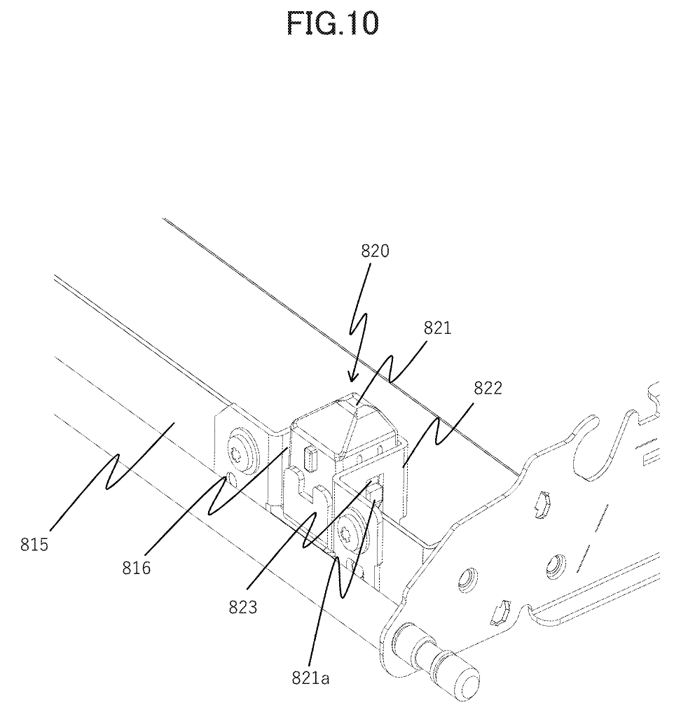

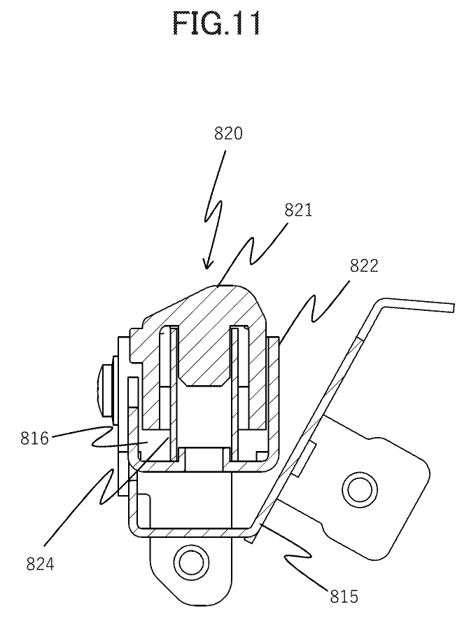

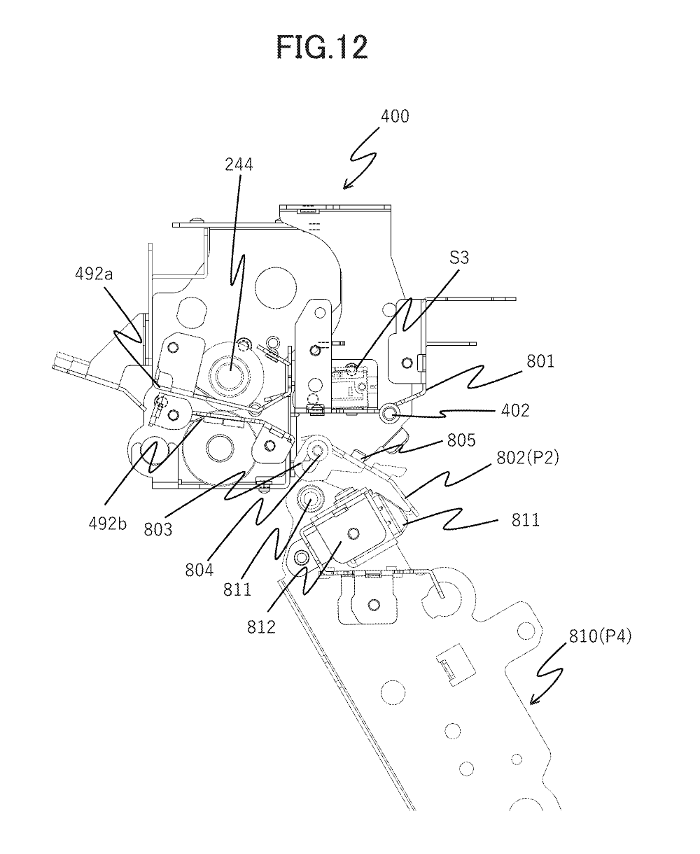

Next, configurations of the opposing guide 802 disposed in the discharge unit 400 and an opening/closing unit 810, serving as a pressing movement unit that opens and closes the opposing guide 802, will be described using FIGS. 6 to 12. FIG. 6 is a cross-sectional view illustrating the discharge unit according to this embodiment. FIG. 7A is a cross-sectional view illustrating the discharge unit and an area adjacent thereto in a state in which the opening/closing unit according to this embodiment is positioned in a pressing position. FIG. 7B is a cross-sectional view illustrating the discharge unit and an area adjacent thereto in a state in which the opening/closing unit according to this embodiment is positioned in a pressing release position. FIG. 8 is a perspective view illustrating a movement guide according to this embodiment. FIG. 9 is a perspective view illustrating the opening/closing unit according to this embodiment. FIG. 10 is an enlarged perspective view illustrating a pressing portion of the opening/closing unit according to this embodiment. FIG. 11 is an enlarged cross-sectional view illustrating the pressing portion of the opening/closing unit according to this embodiment. FIG. 12 is a cross-sectional view illustrating the discharge unit in a state in which the opening/closing unit according to this embodiment was moved to the pressing release position.

As illustrated in FIG. 6, upstream of the discharge roller pair 244 in the sheet conveyance direction D, the sensor fixing guide 801 forming an upper portion of the conveyance path 491 for guiding a conveyed sheet and the opposing guide 802 opposed thereto are disposed. The opposing guide 802, as described in detail below, is pivotably disposed with respect to a support shaft 804, serving as a first pivot shaft, between an opposing position P1, which constitutes a first position as illustrated in FIG. 6, and an open position P2, which constitutes a second position. That is, the opposing guide 802 forms the conveyance path 491 in the opposing position P1, and, when pivoted from the opposing position P1 to the open position P2 located below the opposing position P1, opens the conveyance path 491. The first lateral registration sensor S3, which, as described above, image-detects the position of the side edge in the width direction of the sheet, that is, detects the position in the width direction W of the sheet, is disposed on the sensor fixing guide 801 on the other side. To be noted, although not illustrated in FIG. 6, the pre-shift sensor S2 described above is also disposed on the sensor fixing guide 801.

As described above, the shift roller unit 430 includes the discharge roller pair 244, the upper guide 492a, and the lower guide 492b, and is movable in the width direction W by the drive of the shift motor 259. Since the upper guide 492a and the lower guide 492b move in the width direction W, the sensor fixing guide 801 and the opposing guide 802 are required to be disposed with a gap from the upper and lower guides 492a and 492b. In order for the first lateral registration sensor S3 to accurately detect the side edge of the sheet conveyed from the registration roller pair 243, it is necessary to narrow a guide gap (distance in a thickness direction of the sheet) between the sensor fixing guide 801 and the opposing guide 802. In this embodiment, the guide gap between the sensor fixing guide 801 and the opposing guide 802 is 2.5 millimeters (mm), while guide gaps in other conveyance paths are 3 mm.

Here, the discharge roller pair 244 is a roller pair disposed most downstream in the sheet conveyance direction D in the sheet feeding apparatus 2. Therefore, when sheet clogging (jam) occurs downstream of the discharge roller pair 244 in the sheet conveyance direction, that is, in the discharge path 492, the discharge path 492 cannot be opened due to the connection of the image forming apparatus 1A. Therefore, in a case of performing the jam clearance (removal) of the sheet, it is necessary to return the sheet to an upstream side of the discharge roller pair 244 in the sheet conveyance direction D and subsequently perform the processing. However, particularly when the guide gap between the sensor fixing guide 801 and the opposing guide 802 is set narrower than the guide gaps of the other conveyance paths, in a case where the discharge roller pair 244 is reversed so as to return the sheet to the upstream side, the trailing edge of the sheet becomes caught. Therefore, under such conditions, there is a concern that the jam clearance in the discharge path 492 may not be performed.

Accordingly, in this embodiment, in a case where the jam (sheet clogging) occurs in the discharge path 492, the opening/closing unit 810 is pivoted to pivot the opposing guide 802; thereby, the conveyance path 491 can be opened. Configurations of the opposing guide 802 and the opening/closing unit 810 will be described in detail below.

To be noted, a knob 410A, serving as a manual drive unit, is drivingly coupled to the discharge drive roller 410 of the discharge roller pair 244. Then, when the user manually drives (rotates in reverse) the knob 410A in a state illustrated in FIG. 7A, it becomes possible to convey the sheet jammed in the discharge path 492 in a direction opposite to the sheet conveyance direction D and send the sheet into the conveyance path 491. From this state, by opening an opening/closing door (not shown), and, as illustrated in FIG. 7B, operating a handle 819 to pivot the opening/closing unit 810 downward and, thereby, opening the opposing guide 802, the sheet located in the conveyance path 491 can be removed.

### Configuration of Opposing Guide

Next, a detailed configuration of the opposing guide 802 will be described using FIG. 8. As illustrated in FIG. 8, the opposing guide 802 is formed in an elongated shape in which the width direction W roughly constitutes a longitudinal direction, and elongated holes 803, serving as engagement holes, are respectively formed at both ends in the width direction W. These elongated holes 803 are disposed such that the support shaft 804 (refer to FIG. 6), which is fixedly supported by the support frame 401 of the discharge unit 400, passes through and engages with the elongate holes 803; that is, the opposing guide 802 is supported in engagement with the support shaft 804. In addition, the elongated holes 803 are formed in an elongated hole shape that permits the opposing guide 802 to move in a direction separating from the sensor fixing guide 801 (refer to FIG. 6); that is, the opposing guide 802 is supported so as to be movable in the vertical direction with respect to the support shaft 804.

On an upper side (upper surface) of the opposing guide 802, abutting shafts 805, serving as abutment portions, are fixedly disposed so as to extend upward at both ends in the width direction W. These abutting shafts 805 are arranged with spacing greater than a maximum width size of the sheet that the sheet feeding apparatus 2 is capable of feeding; that is, the abutting shafts 805 are disposed outside in the width direction W of a region through which the sheet passes in the conveyance path 491. Then, the abutting shafts 805 have, for example, a height of 2.5 mm, and, by abutting against the sensor fixing guide 801, establish a distance of the conveyance path 491 in the thickness direction of the sheet. In other words, by abutting the abutting shafts 805 against the sensor fixing guide 801, the opposing guide 802 is positioned at the correct position.

### Configuration of Opening/closing Unit

Next, using FIGS. 9 to 11, the configuration of the opening/closing unit 810, serving as the pressing movement unit, particularly, a detailed configuration of the pressing portion 820, will be described.

As illustrated in FIG. 9, the opening/closing unit 810 includes a pivot shaft 811, serving as a second pivot shaft, supported by the apparatus body frame 201, and is disposed so as to be pivotable as a whole with respect to the pivot shaft 811. In addition, a rotation shaft 817 is rotatably disposed in the opening/closing unit 810, and a hook 818 and the handle 819 are fixedly disposed on the rotation shaft 817. The rotation shaft 817 is urged in one direction of rotation by a spring (not shown), and, in a case where the opening/closing unit 810 is in a pressing position P3 for pressing the opposing guide 802 as illustrated in FIG. 7A, the rotation shaft 817 is engaged with a pin (not shown) disposed on the apparatus body frame 201. Thereby, the opening/closing unit 810 is locked to the apparatus body frame 201 (i.e., the apparatus body). In addition, when the user operates the handle 819 while resisting an urging force of the spring, the hook 818 is disengaged from the pin (not shown) disposed on the apparatus body, and the lock is released. Thereby, as illustrated in FIG. 7B, the opening/closing unit 810 is pivoted to the pressing release position P4.

In addition, as illustrated in FIG. 9, the opening/closing unit 810 is provided with pressing portions 820 disposed adjacent to both ends in the width direction W for pressing the opposing guide 802 upward from below. That is, the opening/closing unit 810 includes a unit frame 815, and piece storage holes 816 are respectively formed at both end portions in the width direction W adjacent to the pivot shaft 811 in the unit frame 815. The pressing portion 820 is stored in this piece storage hole 816.

In particular, as illustrated in FIGS. 10 and 11, a pressurizing plate 822 formed in a box shape with an upper opening is fixed to the unit frame 815, and the piece storage hole 816 is formed inside the pressurizing plate 822. A pressing piece 821 and a pressurizing spring 824 are stored in the piece storage hole 816. In addition, a groove 823 is formed in the pressurizing plate 822, and is engaged with a protrusion 821a that is formed on the pressing piece 821 so as to be movable in the vertical direction. In the pressing portion 820 configured as described above, the pressing piece 821 is urged upward with respect to the unit frame 815 and the pressurizing plate 822 by the pressurizing spring 824, and, while being guided in the vertical direction by the groove 823, the protrusion 821a is retained against detachment.

### Opening/closing Operation of Opposing Guide

Using FIGS. 6, 7A, 7B and 12, an opening/closing operation of the opposing guide 802 by the opposing guide 802, configured as described above, and the opening/closing unit 810 will be described.

As illustrated in FIGS. 7B and 12, when the user operates the handle 819 to release the lock, the opening/closing unit 810 pivots around the pivot shaft 811 as a center, and is moved to the pressing release position P4. Thereby, the pressing portion 820 is gradually separated from the opposing guide 802, and the application of pressure against the opposing guide 802 is released. Thereby, in a form in which the opposing guide 802 falls naturally, the elongated hole 803 is guided along the support shaft 804, and the support shaft 804 abuts against an upper end of the elongated hole 803. Then, the opposing guide 802 pivots to the open position P2 around the support shaft 804 as a fulcrum in a naturally falling manner, and opens the conveyance path 491. Thereby, the opposing guide 802 moves downward with respect to the lower guide 492b of the discharge path 492 by an amount corresponding to a relative sliding movement of the support shaft 804 within the elongated hole 803; in other words, a space larger than the discharge path 492 in the vertical direction is formed. Thereby, when the user manually operates the knob 410A to reverse the discharge roller pair 244 as described above, the jammed sheet can be sent from the discharge path 492 to the conveyance path 491 without engaging the opposing guide 802. Then, the sheet moved from the discharge path 492 to the conveyance path 491 can be removed by the user inserting a hand into the large space, which the opposing guide 802 has opened, to perform the operation.

On the other hand, as illustrated in FIGS. 6 and 7A, when the user operates the handle 819 to pivot the opening/closing unit 810 from the pressing release position P4 to the pressing position P3, while pressing the opposing guide 802, the pressing portion 820 pivots to the opposing position P1 opposing the sensor fixing guide 801. At this time, since the pressing portion 820 presses the opposing guide 802 from below, the abutment shaft 805 of the opposing guide 802 abuts against the sensor fixing guide 801 as described above, and the opposing guide 802 is positioned. Thereby, the conveyance path 491 is formed in a state in which the guide gap of the conveyance path 491 is ensured. In addition, since the pressurizing spring 824 of the pressing portion 820 continuously presses the opposing guide 802 toward the sensor fixing guide 801, a relative position of the opposing guide 802 with respect to the sensor fixing guide 801 is continuously maintained to be at the correct position. Thereby, the guide gap that is narrower than those of the other conveyance paths in the conveyance path 491 is maintained with high accuracy, and the image detection of the sheet by the first lateral registration sensor S3 fixed to the sensor fixing guide 801 can be performed with high accuracy.

In addition, when connected to the image forming apparatus 1A, as described above, the discharge unit 400 pivots around the front and rear side pivot shafts 402 and 403 as the fulcrums so as to allow the height of the discharge path 492 to be adjusted. Then, positions at which the pressing pieces 821 of the pressing portions 820 press the opposing guide 802 are located closer to the front and rear side pivot shafts 402 and 403 than to the pivot shaft 811 by which the opening/closing unit 810 is pivotably supported. That is, the positions at which the pressing pieces 821 of the pressing portions 820 press the opposing guide 802 are positioned adjacent to the front and rear side pivot shafts 402 and 403. Thereby, irrespective of any pivot positions assumed by the discharge unit 400, the position of the opposing guide 802 does not substantially change, and the pressing portions 820 can stably press the opposing guide 802.

### Summary of This Embodiment

In the sheet feeding apparatus 2 according to this embodiment described above, since the sheet feeding apparatus 2 is connected to the image forming apparatus 1A, it is difficult to employ a structure which opens the discharge path 492. However, the opposing guide 802 is configured to pivot with respect to the sensor fixing guide 801 so as to enable opening of the conveyance path 491. Thereby, the sheet jammed by the discharge roller pair 244 can be conveyed by reversing its direction upstream in the sheet conveyance direction D, and the jammed sheet can be removed from the conveyance path 491 which has been opened. Accordingly, it is possible to easily perform the jam clearance in the discharge path 492 that discharges the sheet outside.

### Possibility of Other Embodiments

In the embodiment described above, the opening/closing unit 810 is disposed to pivot so as to open and close the opposing guide 802. However, it is not limited to this, and, without disposing the opening/closing unit 810, the opposing guide 802 may be directly pivoted by the user so as to open the conveyance path 491.

In addition, in this embodiment, the opening/closing unit 810 pivots with respect to the pivot shaft 811. However, it is not limited to this, and the opening/closing unit 810 may move in any direction as long as it can press and pivot the opposing guide 802, such as, for example, performing a sliding movement in the vertical direction.

Further, in this embodiment, the first lateral registration sensor S3 is disposed on the sensor fixing guide 801; however, it is not limited to this, and the guide may be a guide that simply forms the conveyance path 491.

Further, in this embodiment, the discharge roller pair 244 performs the lateral deviation registration correction, that is, the roller pair can shift in the width direction W; however, this embodiment is not limited to this, and the roller pair may simply convey the sheet. Similarly, in this embodiment, the discharge roller pair 244 also has a function as a so-called registration roller pair that performs skew correction; however, it is not limited to this, and the roller pair may simply convey the sheet.

In addition, in this embodiment, the conveyance path 491, the discharge roller pair 244, the discharge path 492, the shift drive structure, the separation drive structure, and the conveyance drive structure are disposed so as to be collectively supported by the discharge unit 400. However, it is not limited to this, and the discharge unit 400 may not include all of these components as long as the discharge unit 400 is provided with the discharge path 492, the discharge roller pair 244, and the conveyance path 491.

In addition, in this embodiment, when the shift roller unit 430, which includes the discharge roller pair 244, moves in the width direction W, the discharge roller pair 244 is moved. However, it is not limited to this, and the discharge roller pair 244 may be directly moved in the width direction W.

In addition, in this embodiment, the image forming system 1 is constituted by the sheet feeding apparatus 2 and the image forming apparatus 1A; however, it is not limited to this. For example, a plurality of sheet feeding apparatuses may be connected in series in the sheet conveyance direction. In addition, one or more processing apparatuses that respectively perform stapling, punching, bookbinding, and inspection may be connected downstream of the image forming apparatus 1A in the sheet conveyance direction. In a case where a plurality of apparatuses are thus connected, an apparatus disposed downstream of a sheet conveyance apparatus that includes a pivotable discharge unit as in this embodiment constitutes a downstream apparatus that receives the sheet discharged from a discharge path.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078140, filed May 8, 2025, which is hereby incorporated by reference herein in its entirety.

What is claimed is:

1. A sheet conveyance apparatus comprising:
a first guide portion including a first guide and a second guide, the second guide being configured to move to a first position opposing the first guide to form a first conveyance path and to a second position that opens the first conveyance path;
a second guide portion disposed downstream of the first guide portion in a sheet conveyance direction and configured to form a second conveyance path;
a detection unit disposed on the first guide and configured to detect a position of a side edge of a sheet;
a conveyance roller pair disposed in the second guide portion and configured to convey the sheet by nipping the sheet; and
a moving unit configured to move the conveyance roller pair based on a detection result of the detection unit in a width direction perpendicular to the sheet conveyance direction in a state in which the sheet is nipped by the conveyance roller pair.

2. The sheet conveyance apparatus according to claim 1, further comprising a pressing movement unit,
wherein the second guide includes an engagement hole that engages with a first pivot shaft, the second guide is pivotably disposed with respect to the first pivot shaft, and the second position is located below the first position,
wherein the pressing movement unit includes a pressing portion that is configured to press the second guide upward by coming into contact with the second guide from below, and
wherein the pressing movement unit is configured to move to a pressing position in which the pressing movement unit presses the second guide to the first position and to a pressing release position in which the pressing movement unit separates the pressing portion from the second guide to allow movement of the second guide to the second position.

3. The sheet conveyance apparatus according to claim 2, wherein the engagement hole is formed in a shape of an elongated hole that allows the second guide to move in a direction separating from the first guide.

4. The sheet conveyance apparatus according to claim 2, wherein the second guide includes an abutment portion that is configured to abut against the first guide in the first position.

5. The sheet conveyance apparatus according to claim 2, wherein the pressing movement unit is pivotably disposed with respect to a second pivot shaft so as to be pivotable between the pressing position and the pressing release position.

6. The sheet conveyance apparatus according to claim 2, further comprising:
an apparatus body frame; and
a support frame configured to support the first guide portion, the conveyance roller pair, and the second guide portion, the support frame being pivotably supported around a third pivot shaft as a center with respect to the apparatus body frame,
wherein the pressing portion is configured to press the second guide at a position that is closer to the third pivot shaft than to the first pivot shaft.

7. The sheet conveyance apparatus according to claim 1, wherein the detection unit is an image reading sensor configured to detect an image of the sheet conveyed to the first conveyance path, and
wherein a distance in a thickness direction of the sheet in the first conveyance path is smaller than that in the second conveyance path.

8. The sheet conveyance apparatus according to claim 7, wherein the moving unit is configured to correct a position in the width direction of the sheet by moving the sheet in the width direction based on a detection result of the image reading sensor.

9. The sheet conveyance apparatus according to claim 8, further comprising a feeding unit configured to feed the sheet toward the first conveyance path.

10. The sheet conveyance apparatus according to claim 9, wherein the feeding unit is configured to feed the sheet by absorbing the sheet through drawing air.

11. The sheet conveyance apparatus according to claim 8, further comprising a separation drive unit,
wherein the conveyance roller pair includes a drive roller and a driven roller that rotates by following the drive roller,
wherein the separation drive unit that is configured to separate the drive roller and the driven roller, and
wherein, in a case where the moving unit moves the conveyance roller pair to move the sheet in the width direction, the separation drive unit is configured to bring the drive roller and the driven roller into pressure contact with each other to nip the sheet, and, in a case where the moving unit returns a position of the conveyance roller pair in the width direction to an initial position, the separation drive unit is configured to separate the drive roller and the driven roller to release the sheet.

12. The sheet conveyance apparatus according to claim 1, further comprising a conveyance drive unit configured to drive the conveyance roller pair so as to convey the sheet in the sheet conveyance direction.

13. The sheet conveyance apparatus according to claim 12, further comprising a manual drive unit configured to manually drive the conveyance roller pair so as to convey the sheet in a direction opposite to the sheet conveyance direction.

14. A sheet conveyance system comprising:
the sheet conveyance apparatus according to claim 1; and
a downstream apparatus connected to the sheet conveyance apparatus downstream in the sheet conveyance direction and configured to receive the sheet discharged from the second conveyance path.

15. An image forming system comprising:
the sheet conveyance apparatus according to claim 1; and
an image forming apparatus including an image forming unit that is configured to form an image on the sheet, the image forming apparatus being connected to the sheet conveyance apparatus downstream in the sheet conveyance direction, the image forming
apparatus being configured to receive the sheet discharged from the second conveyance path and form the image on the sheet that has been received.
